(19) United States
(12) Patent Application Publication
(10) Pub. No.: US 2019/0162144 A1
(43) Pub. Date: May 30, 2019

(54) METHOD FOR MANUFACTURING AN INJECTOR FOR INJECTING FUEL

(71) Applicant: Robert Bosch GmbH, Stuttgart (DE)

(72) Inventors: Dietmar Schmieder, Markgroeningen (DE); Nobert Redlich, Hirschaid (DE); Philipp Rogler, Stuttgart (DE)

(21) Appl. No.: 16/309,843

(22) PCT Filed: Jun. 14, 2017
(86) PCT No.: PCT/EP2017/064492

§ 371 Date: Dec. 13, 2018

(30) Foreign Application Priority Data
Jun. 27, 2016 (DE) 10 2016 211 446.8

(51) Int. Cl. F02M 61/12; F02M 61/16

(52) U.S. Cl. CPC F02M 61/12; F02M 2200/80; F02M 61/168

(57) ABSTRACT

A method for manufacturing an injector for injecting fuel, the injector including: a closing body which is linearly movable in an axial direction and a valve seat element having at least one passage for injecting the fuel, a valve seat with which the closing body is in contact for closing off the at least one passage, and a guide area for guiding the closing body when same is moving in the axial direction, the method being characterized in that the valve seat and the guide area are hard turned.

### FIELD OF THE INVENTION

The present invention relates to a method for manufacturing an injector for injecting fuel. Furthermore, the present invention relates to an injector, in particular manufactured according to the method according to the present invention.

### BACKGROUND INFORMATION

Injectors for injecting fuel are known from the related art in various embodiments. Usually, the injectors include a valve sleeve. A valve seat element is situated in the valve sleeve or integrally implemented. A closing body which is linearly movable in the axial direction is situated in the valve sleeve. The valve seat element includes at least one passage (spray opening) for injecting the fuel. Furthermore, a valve seat and a guide area are implemented in the valve seat element. The closing body for closing off the at least one passage sits in the valve seat.

The guide area is used to guide the closing body when same is moving in the axial direction. When manufacturing the valve seat element, the valve seat and the guide area are stamped for tolerance reasons. In some cases, it is also necessary to spherically hone the valve seat in the case of increased tightness requirements. Furthermore, there are manufacturing methods in which the valve seat is ground.

### SUMMARY OF THE INVENTION

The method according to the present invention for manufacturing the injector having the features described herein provides that the valve seat as well as the guide area is hard turned inside the valve seat element. It has been found within the scope of the present invention that the hard turned valve seats and guide areas no longer require stamping and/or no longer require grinding and/or no longer require honing. Hard turning may be used to manufacture very precise valve seats and guide areas which meet high tightness requirements. In particular, hard turning allows for processing very small valve seat diameters and guide diameters. Hard turning allows for the valve seat element to be manufactured with relatively little effort and correspondingly at low cost. All these advantages are achieved with the aid of the method according to the present invention for manufacturing an injector for injecting fuel. In this case, the injector includes a closing body, which is linearly movable in the axial direction, and a valve seat element. The valve seat element includes at least one passage for injecting the fuel. The passage is also referred to as a spray hole. Furthermore, a valve seat and a guide area are implemented in the valve seat element. In the closed state of the injector, the closing body sits in the valve seat, rendering it impossible for fuel to be injected into the combustion chamber through the at least one passage. In the open state of the injector, the closing body is spaced apart from the valve seat, so that fuel is injectable through the at least one passage. The guide area in the valve seat is used to guide the closing body when same is moving in the axial direction. At its combustion chamber-side end, the closing body may include a ball or a ball-shaped element. This ball or the ball-shaped element is linearly movably guided in the guide area. According to the present invention, it is provided that the valve seat as well as the guide area are hard turned. In this case, it may be provided that after hard turning, the valve seat and the guide area are not ground and/or not honed. Within the scope of this present invention, a surface may be considered “hard turned” if it is processed while being turned at a hardness of at least 440 HV10. HV10 represents Vickers hardness at a test force of 10 kiloponds (approximately 98 newtons).

The further descriptions herein describe further refinements of the present invention.

The injector may include a valve sleeve. The valve seat element may be manufactured as a single-piece element separately from the valve sleeve and hard turned. After completing the valve seat element, the valve seat element is connected to the valve sleeve. The mechanism for linearly moving the closing body is located in the valve sleeve. In this case, the valve sleeve is used to center this mechanism or the closing body. On the combustion chamber side, the closing body is guided and centered in the guide area of the valve seat element. The mechanism for linearly moving the closing body may in particular include electromagnetic components for actuating the closing body.

It may be provided that the contours of the valve seat and of the guide area are initially soft turned. Subsequently, the valve seat element is hardened at least in the area of the valve seat and of the guide area. After the hardening, the valve seat and the guide area are hard turned. As a result of this procedure, it may be that little material must be removed during the hard turning. This results in a rapid and cost-effective manufacturing method.

The guide area may include several grooves and webs situated in-between. The grooves and the webs extend in parallel to the axial direction. The closing body, in particular the ball or the ball-shaped element of the closing body, is in contact with the webs. A guide diameter of the guide area corresponds in this case to an outer diameter of this ball or of this ball-shaped element, so that the closing body does not move in the direction which is perpendicular to the axial direction. It may be provided that all webs of the guide area are simultaneously hard turned.

For a very precise manufacture of the valve seat and of the guide area, it may be provided that the valve seat and the guide area are hard turned when the valve seat element is clamped. The valve seat element is thus clamped in the lathe once in order to hard turn the valve seat and the guide area.

The present invention further includes an injector for injecting fuel. The injector may be manufactured according to the method described above. The injector includes the closing body, which is linearly movable in an axial direction, and the valve seat element. The valve seat element includes the at least one passage for injecting the fuel. Furthermore, the described valve seat and the described guide area are implemented in the valve seat element. The valve seat and the guide area are hard turned in this case. After the hard turning, the valve seat and the guide area may be not ground and/or not honed. Those skilled in the art are able to determine whether a hard turned surface is involved through a simple examination of the surfaces at the valve seat and at the guide area. In this case, a surface is considered “hard turned” if it was processed while being turned at a hardness of at least 440 HV10.

At the valve seat and at the guide area, the valve seat element may have a material hardness of at least 440 HV10, which may be at least 500 HV10, particularly at least 550 HV10.

The valve seat has a valve seat diameter perpendicular to the axial direction. The valve seat diameter is defined by the contact surface of the closing body on the valve seat. It may be provided that the valve seat diameter is maximally 3 mm, in particular maximally 2 mm.

A guide diameter is defined at the guide area perpendicular to the axial direction. In particular, this guide diameter is provided by the webs of the guide area. A diameter of the ball or of the ball-shaped element of the closing element corresponds to the guide diameter. The guide diameter may be maximally 5 mm, particularly maximally 4 mm.

A minimum wall thickness is defined at the valve seat element in the direction of the combustion chamber. The passages (spray holes) may include an area having a small passage diameter and another area having a larger passage diameter. The minimum wall thickness of the valve seat element corresponds to a length of the area having the smallest passage diameter. The minimum wall thickness may be maximally 0.8 mm, particularly maximally 0.7 mm, in particular maximally 0.6 mm.

It may be provided that the guide area and the valve seat are situated coaxially to one another. The coaxiality deviates in this case by maximally 0.03 mm, which may be by maximally 0.02 mm, in particular by maximally 0.01 mm. This means that the center axes of the valve seat and of the guide area are spaced apart from one another by maximally 0.03 mm or 0.02 mm or 0.01 mm, respectively.

Within the scope of the present invention, it has been demonstrated that by hard turning, in contrast to grinding and honing, it is possible to extremely precisely process very hard materials having small diameters and low wall thicknesses in an efficient manner. For this reason, the dimension data listed above may be used.

The advantageous embodiments and subclaims described within the scope of the method according to the present invention may be used in the case of the injector according to the present invention. The advantageous embodiments and subclaims described within the scope of the injector according to the present invention may be used in the case of the method according to the present invention.

Exemplary embodiments of the present invention are described in detail below with reference to the attached drawings.

### BRIEF DESCRIPTION OF THE DRAWINGS

FIG. 1 shows a sectional view of an injector according to the present invention manufactured according to the method according to the present invention according to one exemplary embodiment.

FIG. 2 shows a detailed view of FIG. 1.

### DETAILED DESCRIPTION

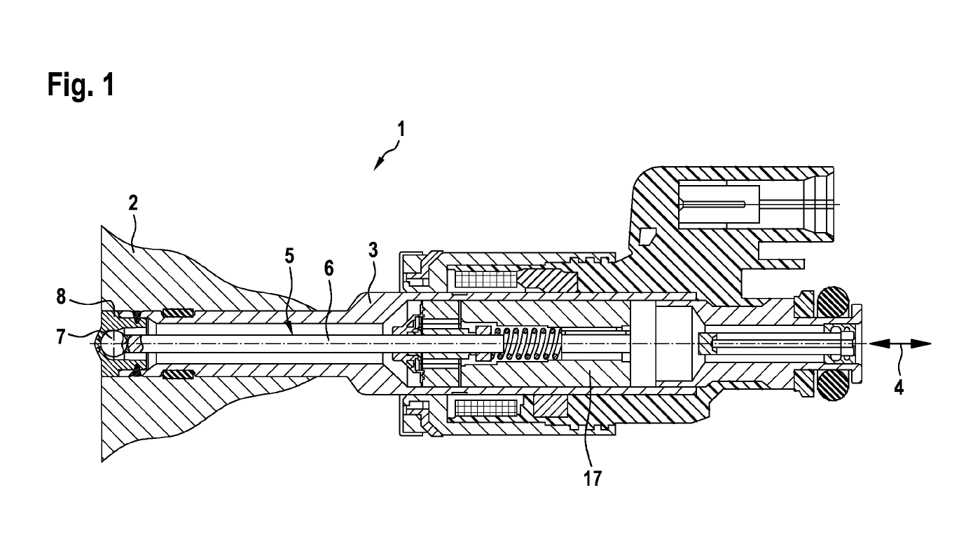

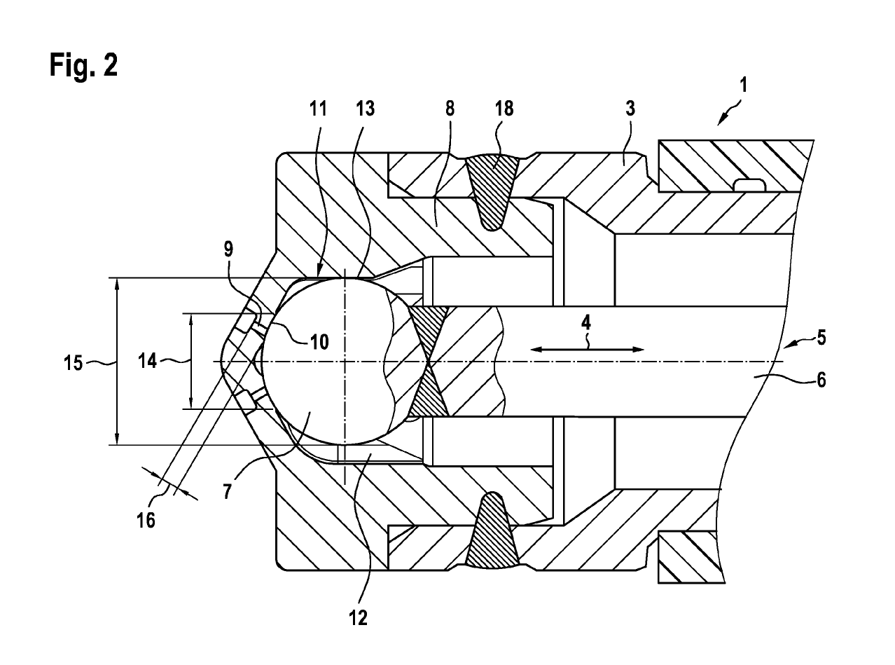

An injector 1 according to one exemplary embodiment of the present invention is described in detail below with reference to FIGS. 1 and 2. Injector 1, in particular a valve seat element 8 of injector 1, is manufactured according to the method according to the present invention.

FIG. 1 shows complete injector 1 in the assembled state. Injector 1 is situated in this case in a bore of an internal combustion engine 2, in particular in a cylinder head. FIG. 2 shows in detail the combustion chamber-side end of injector 1. Injector 1 includes a valve sleeve 3. In valve sleeve 3, a closing body 5 is accommodated linearly movably in an axial direction 4. Closing body 5 includes a rod 6 and a ball 7. Ball 7 is fastened to rod 6 on the combustion chamber side.

Furthermore, a mechanism 17 is situated in valve sleeve 3. Rod 6 of closing body 7 is fastened in this mechanism 17. Mechanism 17 is used to linearly move closing body 5 and thus to open and close injector 1.

Injector 1 further includes a valve seat element 8. Valve seat element 8 is accommodated in valve sleeve 3 and connected to valve sleeve 3 via a weld seam 18. Valve seat element 8 includes a hollow space in which ball 7 of closing body 5 is accommodated. At the side of ball 7, a guide area 11 is formed in valve seat element 8 for guiding closing body 5. Furthermore, valve seat element 8 includes a valve seat 10. In the closed state of injector 1, ball 7 sits on valve seat 10.

Passages 9 are formed at the combustion chamber-side end of valve seat element 8. Guide area 11 includes several webs 13 which are spaced apart from one another by grooves 12. Ball 7 is in contact with webs 13. The fuel to be injected flows through grooves 12 and passages 9 into the combustion chamber.

Valve seat 10 as well as guide area 11, in particular the side of webs 13 facing inward, were hard turned. For this purpose, the contours of valve seat 10 and of guide area 11 were initially manufactured by soft turning. Subsequently, valve seat element 8 was hardened and hard turned.

FIG. 2 further shows a valve seat diameter 14. Valve seat diameter 14 is measured perpendicularly to axial direction 4 and is defined by a contact surface of ball 7 on valve seat 10 in the closed state of injector 1.

Furthermore, FIG. 2 shows a guide diameter 15 which corresponds to the distance between opposing webs 13 of guide area 11 or to a diameter of ball 7.

According to FIG. 2, passages 9 include an inner area having a very small passage diameter. This area defines a minimum wall thickness 16 of valve seat element 8.

Valve seat diameter 14, guide diameter 15, minimum wall thickness 16 as well as the hardness of the material at guide area 11 and valve seat 10 may be selected in the same way as described in the general part of the description and in the subclaims.

1-10. (canceled)

11. A method for manufacturing an injector for injecting fuel, the method comprising:
providing a closing body, which is linearly movable in an axial direction and a valve seat element, having at least one passage for injecting the fuel, a valve seat with which the closing body is in contact for closing off the at least one passage, and a guide area for guiding the closing body when it is moving in the axial direction; and
hard turning the valve seat and the guide area.

12. The method of claim 11, wherein contours of the valve seat and of the guide area are initially soft turned, wherein subsequently, the valve seat element is hardened at least at the valve seat and at the guide area, and wherein after the hardening, the valve seat and the guide area are hard turned.

13. The method of claim 11, wherein the guide area includes several grooves and webs situated in-between, the closing body being in contact with the webs and all of the webs being simultaneously hard turned.

14. The method of claim 11, wherein the valve seat and the guide area are hard turned when the valve seat element is clamped.

15. An injector for injecting fuel, comprising:
a closing body, which is linearly movable in an axial direction and a valve seat element, having at least one passage for injecting the fuel, a valve seat with which the closing body is in contact for closing off the at least one passage, and a guide area for guiding the closing body when it is moving in the axial direction;
wherein the valve seat and the guide area are hard turned.

16. The injector of claim 15, wherein the valve seat element has a material hardness of at least 440 HV10 at the valve seat and at the guide area.

17. The injector of claim 15, wherein the valve seat has a valve seat diameter perpendicular to the axial direction, the valve seat diameter being maximally 3 mm.

18. The injector of claim 15, wherein the guide area has a guide diameter perpendicular to the axial direction, the guide diameter being maximally 5 mm.

19. The injector of claim 15, wherein a minimum wall thickness is defined at the valve seat element, the minimum wall thickness corresponding to the length of the passage, with only that area of the passage being taken into account which has the smallest passage diameter, and the minimum wall thickness being maximally 0.8 mm.

20. The injector of claim 15, wherein the valve seat and the guide area are situated coaxially to one another, the coaxiality deviating by maximally 0.03 mm.

21. The injector of claim 15, wherein the valve seat element has a material hardness of at least 500 HV10 at the valve seat and at the guide area.

22. The injector of claim 15, wherein the valve seat element has a material hardness of at least 550 HV10, at the valve seat and at the guide area.

23. The injector of claim 15, wherein the valve seat has a valve seat diameter perpendicular to the axial direction, the valve seat diameter being maximally 2 mm.

24. The injector of claim 15, wherein the guide area has a guide diameter perpendicular to the axial direction, the guide diameter being maximally 4 mm.

25. The injector of claim 15, wherein a minimum wall thickness is defined at the valve seat element, the minimum wall thickness corresponding to the length of the passage, with only that area of the passage being taken into account which has the smallest passage diameter, and the minimum wall thickness being maximally 0.7 mm.

26. The injector of claim 15, wherein a minimum wall thickness is defined at the valve seat element, the minimum wall thickness corresponding to the length of the passage, with only that area of the passage being taken into account which has the smallest passage diameter, and the minimum wall thickness being maximally 0.6 mm.

27. The injector of claim 15, wherein the valve seat and the guide area are situated coaxially to one another, the coaxiality deviating by maximally 0.02 mm.

28. The injector of claim 15, wherein the valve seat and the guide area are situated coaxially to one another, the coaxiality deviating by maximally 0.01 mm.
